(19) United States
(12) Patent Application Publication
(10) Pub. No.: US 2015/0212037 A1
(43) Pub. Date: Jul. 30, 2015

(54) LAMINATED GAS SENSOR ELEMENT, GAS SENSOR, AND METHOD OF MANUFACTURING GAS SENSOR ELEMENT

(71) Applicant: NGK SPARK PLUG CO., LTD., Nagoya-shi (JP)

(72) Inventors: Satoshi OKAZAKI, Kasugai-shi (JP); Akinori KOJIMA, Ichinomiya-shi (JP)

(21) Appl. No.: 14/601,003

(22) Filed: Jan. 20, 2015

(30) Foreign Application Priority Data
Jan. 24, 2014 (JP) 2014-011385
Oct. 17, 2014 (JP) 2014-212197

(51) Int. Cl. G01N 27/407

(52) U.S. Cl. CPC G01N 27/4071

(57) ABSTRACT

A laminated gas sensor element includes a plurality of laminated plate-shaped members, including a plate-shaped insulating member in which a solid electrolyte body is embedded and which has four sides. The solid electrolyte body is formed such that, as viewed in a plane orthogonal to a thickness direction of the insulating member including the solid electrolyte body, a portion of the contour of the solid electrolyte body facing at least one side of the four sides of the insulating member has an arcuate shape projecting toward the one side.

### CROSS REFERENCE TO RELATED APPLICATIONS

The present application claims priority to Japanese Patent Applications No. 2014-011385, filed on Jan. 24, 2014 and Japanese Patent Applications No. 2014-212197, filed on Oct. 17, 2014, the disclosures of which are incorporated herein by reference in their entirety.

### BACKGROUND OF THE INVENTION

1. Field of the Invention

The present invention relates to a laminated gas sensor element, a gas sensor, and a method of manufacturing the gas sensor element.

2. Description of Related Art

An example of a known gas sensor for detecting a particular gas is an oxygen sensor including a cell which has a pair of electrodes disposed on the outer surface of a solid electrolyte body. An example of a known sensor element used in such a gas sensor is a laminated gas sensor element formed by laminating a plurality of plate-shaped members (below listed Patent Documents 1 and 2). In the conventional laminated gas sensor element, the solid electrolyte body is embedded in a through-hole formed in a flat plate-shaped insulating member, and has a rectangular contour shape.

### RELATED ART DOCUMENTS

Patent Document 1 is Japanese Patent No. 4050542.

Patent Document 2 is Japanese Patent No. 4669429.

### BRIEF SUMMARY OF THE INVENTION

However, since the solid electrolyte body whose contour shape is rectangular is dense, the conventional gas sensor element has a problem in that, when an external force or a stress such as thermal stress acts on the solid electrolyte body, stress concentration is likely to occur at the four corners thereof, and the solid electrolyte body breaks easily. Also, the conventional gas sensor element has a problem in that, when the solid electrolyte body is embedded in the through-hole of the insulating member, a gap is formed between the solid electrolyte body and the insulating member, and the gap serves a bypass passage for gas, which may result in deterioration of sensor performance.

The present invention has been accomplished in order to solve the above problem and can be embodied in the following modes.

(1) One mode of the present invention is a laminated gas sensor element comprising a plurality of laminated plate-shaped members, including a plate-shaped insulating member in which a solid electrolyte body is embedded and which has four sides. In the laminated gas sensor element, as viewed in a plane orthogonal to a thickness direction of the insulating member including the solid electrolyte body (i.e., a top or bottom plan view, where the front, rear, and side elevational views are views of each of the four sides of the plate-shaped insulating member), a portion of a contour of the solid electrolyte body has an arcuate shape projecting toward at least one side of the four sides. In other words, a portion of the contour of the solid electrolyte body, the portion facing at least one side of the four sides, forms an arcuate shape projecting toward the one side.

According to this mode, the solid electrolyte body has a contour which forms an arcuate shape projecting toward at least one side of the four sides of the insulating member. Therefore, when an external force or a stress such as thermal stress acts on the solid electrolyte body, stress concentration is less likely to occur, as compared with the case where the contour forms a rectangular shape as in the case of conventional gas sensor elements. Therefore, the laminated gas sensor element of the present mode does not break easily.

(2) In the above-described gas sensor element, a shape (the contour shape) of the solid electrolyte body is a circle, an ellipse, or a rectangle with rounded short sides (i.e., a rectangular shape where the short sides are arcuate or rounded).

According to this mode, stress concentration can be mitigated to a greater degree.

(3) In the above-described gas sensor element, a portion (another portion) of the contour of the solid electrolyte body has a shape of a longitudinally extending straight line facing a longitudinally extending side of the four sides. In other words, a portion of the contour of the solid electrolyte body, the portion facing a longitudinally extending side of the four sides, forms the shape of a longitudinally extending straight line.

According to this mode, the area of the solid electrolyte body can be made sufficiently large.

(4) Another mode of the present invention is a method of manufacturing the above-described gas sensor element (as described with reference to identifiers (1), (2), or (3)). The method comprises (a) a step of forming a green solid electrolyte layer formed of a green solid electrolyte material on a support sheet; (b) a step of removing, from the green solid electrolyte layer on the support sheet, (a portion of) the green solid electrolyte material, excluding a green solid electrolyte body which is to become the solid electrolyte body of the gas sensor element; (c) a step of transferring the green solid electrolyte body onto a green insulating layer formed of a green insulating material; and (d) a step of forming a green plate-shaped member in which the green solid electrolyte body is surrounded by the green insulating material by applying the green insulating material by means of printing on the green insulating layer in a region around the transferred green solid electrolyte body

According to this manufacturing method, a green insulating layer is formed, by means of screen printing, around a green solid electrolyte body formed on a support sheet. Therefore, it is possible to form a green plate-shaped member in which the green solid electrolyte body is surrounded by the green insulating layer without formation of a gap therebetween. Accordingly, it is possible to prevent deterioration of sensor performance, which deterioration would otherwise occur due to presence of a gap between the solid electrolyte body and the insulating layer.

The present invention can be implemented in various forms; for example, a gas sensor element, a gas sensor, a gas detection apparatus including the gas sensor, a vehicle having the gas detection apparatus mounted thereon, and methods of manufacturing the same.

### BRIEF DESCRIPTION OF THE DRAWINGS

Illustrative aspects of the invention will be described in detail with reference to the following figures wherein:

FIG. 1 is a schematic sectional view showing the internal structure of a gas sensor.

FIG. 2 is a schematic perspective view showing the structure of a gas sensor element.

FIG. 3 is a schematic exploded perspective view showing the gas sensor element.

FIGS. 4(A)-4(E) are plan views showing various shapes of a solid electrolyte body.

FIGS. 5(A)-5(C) are explanatory views showing a first method of manufacturing a plate-shaped member including a solid electrolyte body and an insulating member.

FIGS. 6(A)-6(E) are explanatory views showing a second method of manufacturing a plate-shaped member including a solid electrolyte body and an insulating member.

FIGS. 7(A)-7(F) are explanatory views showing a third method of manufacturing a plate-shaped member including a solid electrolyte body and an insulating member.

### DETAILED DESCRIPTION OF EXEMPLARY EMBODIMENTS OF THE INVENTION

A. Overall Structure of Gas Sensor:

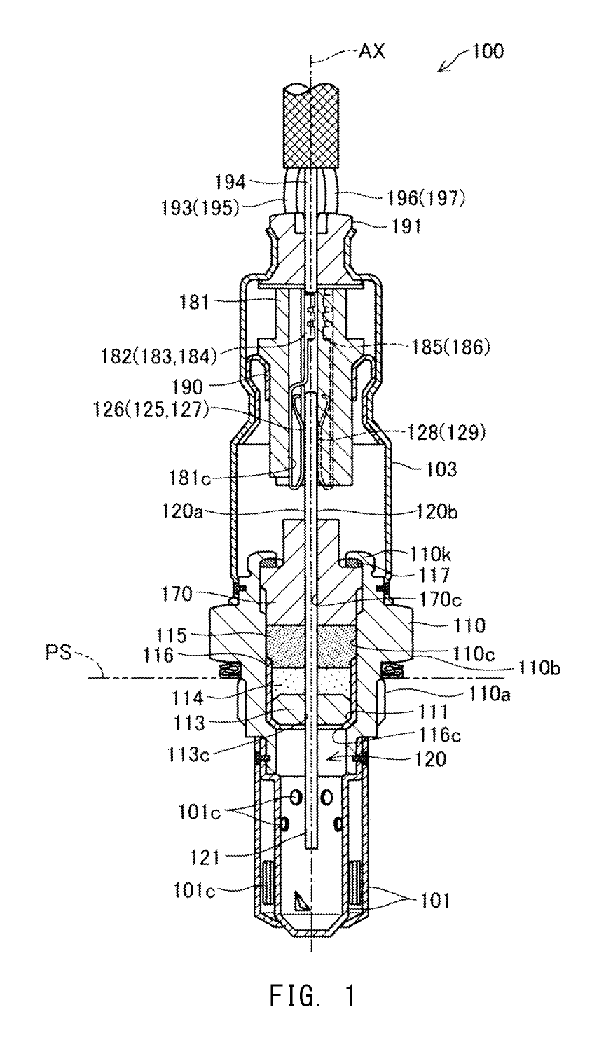

FIG. 1 is a schematic view showing the internal structure of a gas sensor 100 according to an embodiment of the present invention. FIG. 1 shows an imaginary center axis AX (hereinafter, may also be called the “axial line AX”) of the gas sensor 100 with the dot-dash line. The gas sensor 100 is a so-called full range air-fuel ratio sensor which is attached to, for example, an exhaust pipe of an internal combustion engine and detects oxygen concentration in exhaust gas (gas to be measured), linearly over a range of a rich region to a lean region.

The gas sensor 100 extends along the axial line AX. The gas sensor 100 is fixedly attached to the outer surface of the exhaust pipe such that a forward portion (a lower portion on the paper on which FIG. 1 appears) is inserted into the exhaust pipe, whereas a rear portion (an upper portion on the paper) protrudes outward from the exhaust pipe. FIG. 1 shows, with a dash-dot-dot line PS, the outer surface of the exhaust pipe on which the gas sensor 100 is attached.

The gas sensor 100 includes a metallic shell 110 adapted to fixedly attach the same to the exhaust pipe. The metallic shell 110 is a tubular metal member which has a through-hole 110c extending therethrough along the axial line AX. The metallic shell 110 externally has a threaded portion 110a which is threadingly engaged with a threaded hole provided in the exhaust pipe for attachment of the gas sensor 100 to the exhaust pipe, and a tool engagement portion 110b with which a tool, such as a spanner or wrench, is engaged in attaching the gas sensor 100 to the exhaust pipe.

A closed-bottomed cylindrical protector 101 having a dual structure is laser-welded to a forward end portion of the metallic shell 110. The dual-structure protector 101 has a plurality of introduction holes 101c formed in inner and outer walls thereof for allowing introduction of exhaust gas into the gas sensor 100 attached to the exhaust pipe.

An outer tube 103 formed of metal is laser-welded to a rear end portion of the metallic shell 110. Three sensor lead wires 193, 194, and 195 and two heater lead wires 196 and 197 are inserted from a rear end portion of the outer tube 103 into the gas sensor 100 for electrical connection between the gas sensor 100 and an external control circuit (not shown). A grommet 191 formed of fluororubber is fitted into the rear end portion of the outer tube 103 for sealing the interior of the outer tube 103, and the five lead wires 193 to 197 are inserted into the outer tube 103 while extending through the grommet 191.

The gas sensor 100 includes a gas sensor element 120 which outputs a signal corresponding to oxygen concentration. The gas sensor element 120 has a laminate structure in which slender plate members are laminated together, and has a rectangular columnar shape having a substantially rectangular section taken perpendicularly to the imaginary center axis AX (details will be described later). The gas sensor element 120 is fixedly held in the through-hole 110c of the metallic shell 110 and is accommodated in the gas sensor 100 along the axial line AX. In FIG. 1, first and second surfaces 120a and 120b of the gas sensor element 120 which face each other in the direction of lamination are oriented leftward and rightward, respectively.

The gas sensor element 120 has a gas detecting section 121 formed at a forward end portion thereof (a lower end portion in FIG. 1) and configured to detect oxygen concentration in exhaust gas. The gas detecting section 121 is disposed within the protector 101. Thus, the gas detecting section 121 is exposed to exhaust gas introduced through the introduction holes 101c of the gas sensor 100 when the gas sensor 100 is attached to the exhaust pipe.

A separator 181 is a tubular insulating member which has a through-hole 181c extending along the axial line AX, and is fixedly held within the outer tube 103 attached to a rear end portion (an upper end portion in FIG. 1) of the metallic shell 110. Specifically, the separator 181 is held within the outer tube 103 while being urged toward the grommet 191 by a substantially tubular urging metal member 190 disposed around the outer circumference of the separator 181. A rear end portion of the gas sensor element 120 is accommodated within the through-hole 181c of the separator 181.

Three sensor electrode pads 125, 126, and 127 are arrayed on the first surface 120a of the gas sensor element 120 at a rear end portion thereof in parallel toward the far side of the paper on which FIG. 1 appears, whereas two heater electrode pads 128 and 129 are arrayed on the second surface 120b at a rear end portion thereof in parallel toward the far side of the paper. Furthermore, three sensor connection terminals 182, 183, and 184 and two heater connection terminals 185 and 186 are disposed within the through-hole 181c of the separator 181 in such a manner as to be in contact with the corresponding electrode pads 125 to 129 of the gas sensor element 120. The sensor and heater connection terminals 182 to 186 are electrically connected to the corresponding five lead wires 193 to 197 which are inserted into the gas sensor 100 through the grommet 191.

The gas sensor element 120 is fixedly held in a tubular space of the metallic shell 110 through the following configurational features. The metallic shell 110 has a stepped portion 111 protruding radially inward into a forward end portion of the through-hole 110c thereof. A metal cup 116 having a through-hole 116c formed in the bottom thereof is disposed within the through-hole 110c of the metallic shell 110 in such a condition that an outer circumferential portion of the bottom thereof is engaged with the stepped portion 111.

A ceramic holder 113 is disposed within the metal cup 116 and on the bottom of the metal cup 116. The ceramic holder 113 is formed of alumina (Al₂O₃) and has a rectangular through-hole 113c formed at the center for allowing the gas sensor element 120 to extend therethrough.

A first powder filler layer 114 (talc) is formed within the metal cup 116 for airtightly holding the gas sensor element 120 which extends through the through-hole 116c of the metal cup 116 and through the through-hole 113c of the ceramic holder 113. The first powder filler layer 114 is formed by filling an internal space of the metal cup 116 above the ceramic holder 113 with talc powder. In this manner, the gas sensor element 120 is held in the through-hole 110c of the metallic shell 110 while being integrated with the metal cup 116, the ceramic holder 113, and the first powder filler layer 114.

Furthermore, a second powder filler layer 115 (talc) is formed, through charging of talc powder, on the first powder filler layer 114 in the through-hole 110c of the metallic shell 110 for securing airtightness between a rear end portion of the metallic shell 110 and the gas detecting section 121 of the gas sensor element 120. Additionally, a ceramic sleeve 170 is disposed on the second powder filler layer 115.

The ceramic sleeve 170 is a tubular member which has a rectangular axial hole 170c extending along the axial line AX for allowing the gas sensor element 120 to extend therethrough. The ceramic sleeve 170 can be formed of alumina. A rear end portion 110k of the metallic shell 110 is crimped radially inward, whereby the ceramic sleeve 170 is pressed toward the second powder filler layer 115 and fixed to the metallic shell 110. A crimp ring 117 is disposed between the ceramic sleeve 170 and the rear end portion 110k of the metallic shell 110.

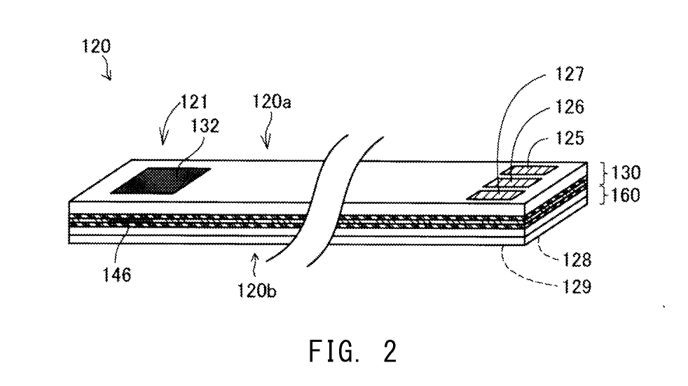

FIG. 2 is a schematic perspective view showing the structure of the gas sensor element 120. FIG. 2 shows the gas sensor element 120 with the first surface 120a facing upward and the second surface 120b facing downward. Also, in FIG. 2, the axial line AX (FIG. 1) extends in the horizontal direction; the forward side of the gas sensor element 120 corresponds to the left side; and the rearward side corresponds to the right side. The gas sensor element 120 is configured such that a plate-shaped detecting element 130 (on the upper side in FIG. 2) and a plate-shaped heater element 160 (on the lower side in FIG. 2) are laminated and fired together.

As described with reference to FIG. 1, the gas sensor element 120 has the gas detecting section 121 formed at a forward end portion thereof. Also, the gas sensor element 120 has the three electrode pads 125 to 127 arrayed on the first surface 120a at a rear end portion thereof. Although unillustrated, the gas sensor element 120 has the two electrode pads 128 and 129 arrayed on the second surface 120b at a rear end portion thereof.

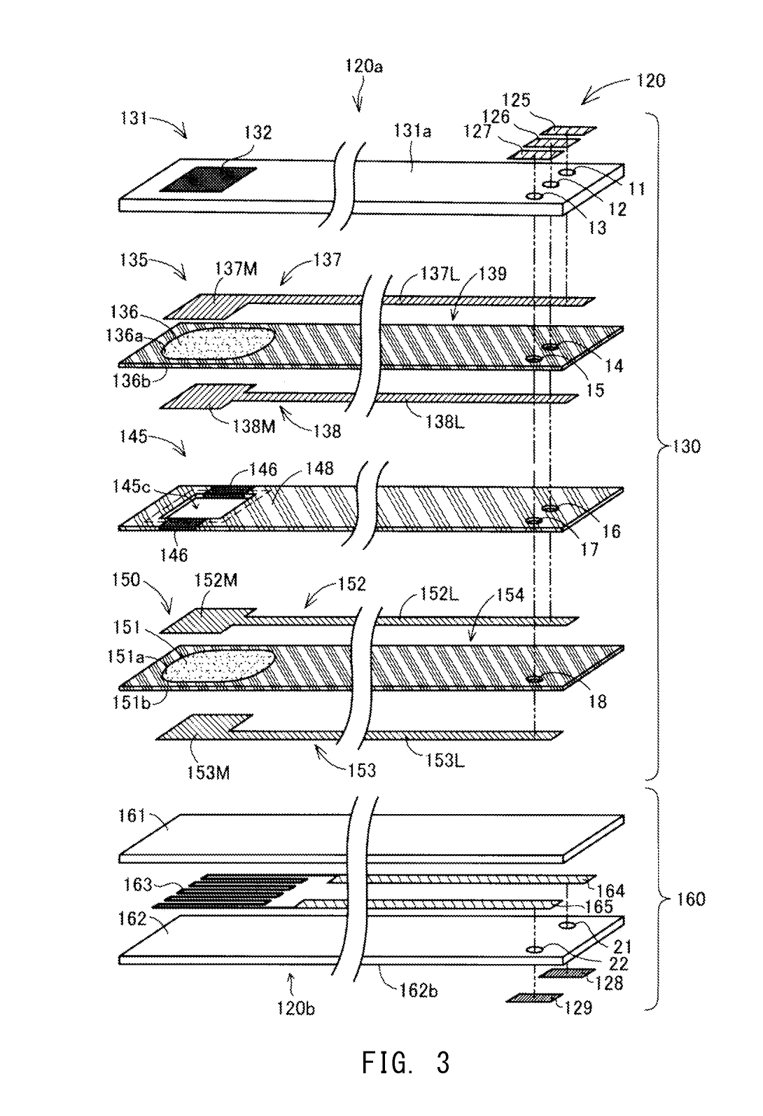

FIG. 3 is a schematic exploded perspective view showing the gas sensor element 120. FIG. 3 shows the gas sensor element 120 in such a manner that components thereof are separated from one another in the direction of lamination (in the vertical direction in the drawing); and, in FIG. 3, the forward side of the gas sensor element 120 corresponds to the left side, and the rearward side corresponds to the right side. In FIG. 3, the dash-dot-dot line indicates that components connected by the dash-dot-dot line electrically communicate with one another. In the detecting element 130 of the gas sensor 100, a protection layer 131, an oxygen pump cell 135, a spacer 145, and an oxygen concentration detection cell 150 are laminated in this order from the first surface 120a side.

The protection layer 131 is a plate-shaped member formed primarily of alumina and protects the gas sensor element 120 from the first surface 120a side. The protection layer 131 has a porous section 132 formed at a forward end portion thereof and being gas-permeable in the direction of lamination thereof (in the vertical direction in FIG. 3). The porous section 132 is formed in such a manner as to overlie an electrode portion 137M, which will be described later, as viewed in the direction of lamination of components of the gas sensor element 120. The porous section 132 functions as a gas flow channel for pumping exhaust gas into or from the gas detecting section 121.

The three electrode pads 125 to 127 are arrayed in parallel in the width direction of the gas sensor element 120 (toward the far side of the paper on which FIG. 3 appears) on an outer surface 131a of the protection layer 131 at a rear end portion thereof. Also, the protection layer 131 has first to third through-hole conductors 11 to 13 formed therein in such a manner as to extend therethrough and correspond to the first to third electrode pads 125 to 127.

The oxygen pump cell 135 is a plate-shaped member which includes a solid electrolyte body 136, an insulating member 139 having the solid electrolyte body 136 disposed therein, and a pair of electrodes 137 and 138. The solid electrolyte body 136 is a plate-shaped member formed of, for example, stabilized zirconia sintered body or partially stabilized zirconia sintered body and having an area slightly greater than those of paired electrode portions 137M and 138M. In the present embodiment, the entire contour of the solid electrolyte body 136 forms a circular shape, or a portion of the counter corresponding to at least one side of the solid electrolyte body 136 (when it has one side or a plurality of sides) forms an arcuate shape. This point will be described in detail later. The insulating member 139 is a plate-shaped member which surrounds the outer perimeter of the solid electrolyte body 136 to cover the circumference of the solid electrolyte body 136 and which has a size substantially the same as that of the protection layer 131. The insulating member 139 has fourth and fifth through-hole conductors 14 and 15 formed therein at a rear end portion thereof in such a manner as to extend therethrough. The fourth and fifth through-hole conductors 14 and 15 electrically communicate with the second and third through-hole conductors 12 and 13, respectively, formed in the protection layer 131. The insulating member 139 is formed of, for example, alumina.

The two electrodes 137 and 138 are formed porously and primarily of platinum (Pt) and have the electrode portions 137M and 138M and lead portions 137L and 138L, respectively. The electrode portions 137M and 138M are disposed on a first surface 136a (an upper surface in FIG. 3) of the solid electrolyte body 136 and a second surface 136b (a lower surface in FIG. 3), respectively. The electrode portion 138M disposed on the second surface 136b is exposed to a gas detecting chamber 145c, which will be described later. The electrode portion 137M disposed on the first surface 136a is exposed to exhaust gas through the porous section 132 provided in the protection layer 131 when the gas sensor 100 is attached to the exhaust pipe.

The lead portions 137L and 138L extend rearward from the electrode portions 137M and 138M, respectively. The lead portion 137L of the electrode 137 disposed on the first surface 136a electrically communicates with the first electrode pad 125 through the first through-hole conductor 11 provided in the protection layer 131. The lead portion 138L of the electrode 138 disposed on the second surface 136b electrically communicates with the second electrode pad 126 through the fourth through-hole conductor 14 provided in the insulating member 139 and through the second through-hole conductor 12 provided in the protection layer 131.

The spacer 145 is a plate-shaped insulating member having a size substantially the same as that of the insulating member 139 of the oxygen pump cell 135. The spacer 145 is formed of, for example, alumina. The spacer 145 has a through-hole formed at a forward end portion thereof. The through-hole partially constitutes the gas detecting chamber 145c, into which exhaust gas to be measured is introduced, when the spacer 145 is sandwiched between the oxygen pump cell 135 and the oxygen concentration detection cell 150.

The spacer 145 has diffusion controlling portions 146 formed at two respective side wall portions which face each other in the width direction of the spacer 145 with the through-hole intervening therebetween. The diffusion controlling portions 146 are formed of gas-permeable porous alumina. In the gas sensor element 120, exhaust gas is introduced into the gas detecting chamber 145c in an amount corresponding to gas permeability of the diffusion controlling portions 146. That is, the diffusion controlling portions 146 function as gas introducing portions of the gas detecting section 121.

The spacer 145 has a sixth through-hole conductor 16 formed therein at a rear end portion thereof in such a manner as to extend therethrough. The sixth through-hole conductor 16 electrically communicates with the lead portion 138L of the electrode 138 of the oxygen pump cell 135. The spacer 145 also has a seventh through-hole conductor 17 formed therein adjacent to the sixth through-hole conductor 16 in such a manner as to extend therethrough. The seventh through-hole conductor 17 electrically communicates with the fifth through-hole conductor 15 provided in the insulating member 139 of the oxygen pump cell 135.

The spacer 145 functions as an insulating layer for electrically insulating the oxygen pump cell 135 and the oxygen concentration detection cell 150 from each other.

The oxygen concentration detection cell 150 is a plate-shaped member which includes a solid electrolyte body 151, an insulating member 154 having the solid electrolyte body 151 disposed therein, and a pair of electrodes 152 and 153. The solid electrolyte body 151 is a plate-shaped member formed of, for example, stabilized zirconia sintered body or partially stabilized zirconia sintered body and having an area slightly greater than those of paired electrode portions 152M and 153M. Like the solid electrolyte body 136 of the oxygen pump cell 135, the entire contour of the solid electrolyte body 151 forms a circular shape, or a portion of the counter corresponding to at least one side of the solid electrolyte body 151 (when it has one side or a plurality of sides) forms an arcuate shape. The insulating member 154 is a plate-shaped member which surrounds the outer perimeter of the solid electrolyte body 151 to cover the circumference of the solid electrolyte body 151 and which has a size substantially the same as that of the spacer 145. The insulating member 154 has an eighth through-hole conductor 18 formed therein at a rear end portion thereof in such a manner as to extend therethrough. The eighth through-hole conductor 18 electrically communicates with the seventh through-hole conductor 17 formed in the spacer 145.

The two electrodes 152 and 153 are formed porously and primarily of platinum (Pt) and have the electrode portions 152M and 153M and lead portions 152L and 153L, respectively. The electrode portions 152M and 153M are disposed on a first surface 151a (an upper surface in FIG. 3) of the solid electrolyte body 151 and a second surface 151b (a lower surface in FIG. 3), respectively. The electrode portion 152M disposed on the first surface 151a is exposed to the gas detecting chamber 145c.

The lead portion 152L of the electrode 152 disposed on the first surface 151a electrically communicates with the electrode 138 of the oxygen pump cell 135 and with the second electrode pad 126 through the sixth through-hole conductor 16 provided in the spacer 145. The lead portion 153L of the electrode 153 disposed on the second surface 150b electrically communicates with the third electrode pad 127 through the eighth through-hole conductor 18 provided in the insulating member 154.

The heater element 160 includes first and second insulators 161 and 162, a heat-generating resistor 163, and first and second heater lead portions 164 and 165. Each of the first and second insulators 161 and 162 is a plate-shaped member formed of alumina and having the same size as the detection element 130. The first and second insulators 161 and 162 holds the heat-generating resistor 163 and the heater lead portions 164 and 165 therebetween.

The heat-generating resistor 163 is a heat-generating wire formed primarily of platinum and having a meandering shape. The two heater lead portions 164 and 165 are connected to respective opposite ends of the heat-generating resistor 163 and extend rearward from the respective opposite ends of the heat-generating resistor 163.

The second insulator 162 has first and second heater electrode pads 128 and 129 arrayed in parallel in the width direction of the heater element 160 on an outer surface 162b of the second insulator 162 at a rear end portion thereof. Also, the second insulator 162 has first and second heater through-hole conductors 21 and 22 formed therein in such a manner as to extend therethrough. The first and second heater through-hole conductors 21 and 22 correspond to the first and second heater electrode pads 128 and 129. The first and second heater lead portions 164 and 165 extending from the heat-generating resistor 163 electrically communicate with the first and second heater electrode pads 128 and 129 through the first and second heater through-hole conductors 21 and 22, respectively.

When the gas sensor 100 is driven, the heater element 160 is controlled in heat temperature by an external heater control circuit (not shown). The heater element 160 heats the detecting element 130 to a temperature of several hundred ° C. (e.g., 700° C. to 800° C.) for activating the oxygen pump cell 135 and the oxygen concentration detection cell 150.

B. Shape of Solid Electrolyte Body and Method of Manufacturing the Same:

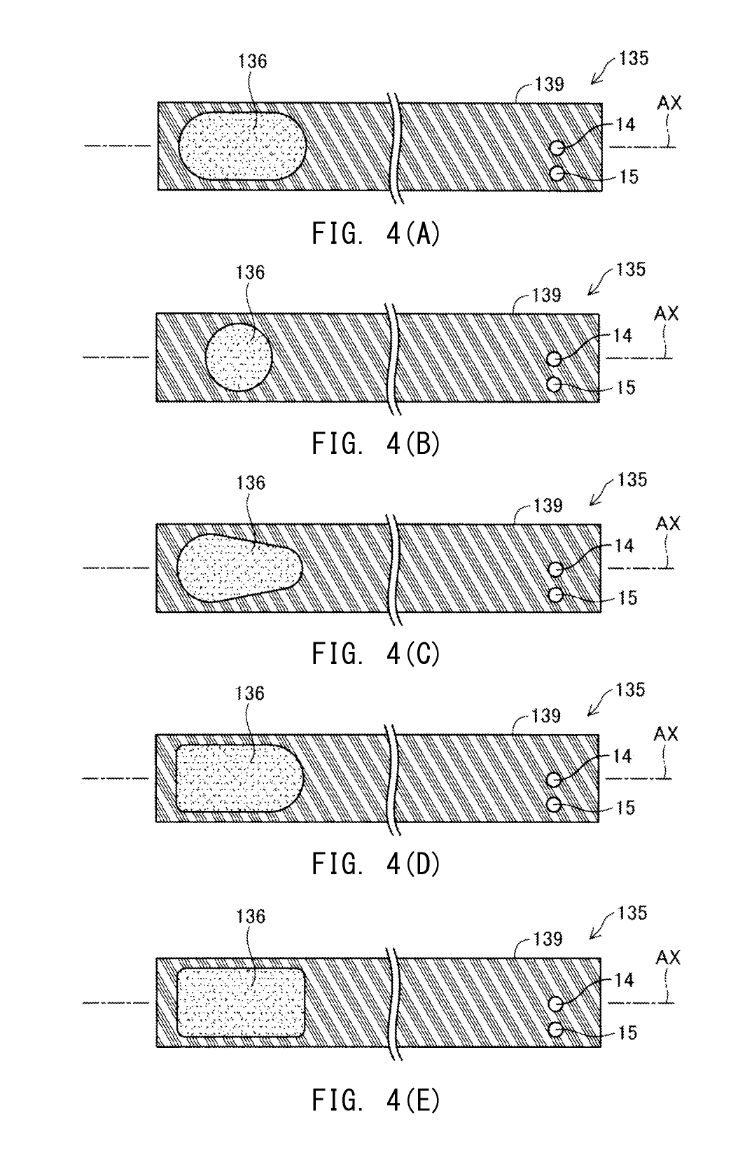

FIGS. 4(A) through 4(E) are plan views showing various contour shapes (planar shapes) which can be employed for the solid electrolyte body 136 of the oxygen pump cell 135. Notably, it is preferred that the solid electrolyte body 151 of the oxygen concentration detection cell 150 have the same shape as that of the solid electrolyte body 136 of the oxygen pump cell 135. In the following description, the solid electrolyte body 136 of the oxygen pump cell 135 is explained as a representative.

The solid electrolyte body 136 of FIG. 4(A) has a plate-like shape, and its contour shape is a flat oval; i.e., a rectangle having rounded short sides and elongated in the direction of the axial line AX of the gas sensor 100. The contour shape of the solid electrolyte body 136 of FIG. 4(B) is a circle. The term “circle” means a true circle. Also, the solid electrolyte body 136 may have an elliptical contour. The solid electrolyte body 136 of FIG. 4(C) has a generally wedge-shaped contour which is elongated in the direction of the axial line AX and is rounded over the entire circumference. However, each of opposite end portions of the generally wedge-shaped contour in the direction of the axial line AX has a generally arcuate shape. Also, the width of the generally wedge-shaped contour is large on the forward end side (on the left-hand side in FIG. 4(c)) and is small on the rear end side (on the right-hand side in FIG. 4(c)). Such a shape is preferred because a gap is less likely to be formed between the solid electrolyte body 136 and the insulating member 139 when the insulating member 139 is formed through screen printing (which will be described later). The contour of the solid electrolyte body 136 of FIG. 4(D) has different shapes at the opposite ends in the direction of the axial line AX. Specifically, the contour of the solid electrolyte body 136 of FIG. 4(D) has an arcuate shape (preferably, a semicircular shape) at one side of the solid electrolyte body 136 which is located on the rear end side (the right-hand side in FIG. 4(D)) thereof, and is straight at the opposite side of the solid electrolyte body 136 which is located on the forward end side (the left-hand side in FIG. 4(D)) thereof. However, two corners on the front end side are rounded (R-chamfered). The solid electrolyte body 136 of FIG. 4(E) is a comparative example, and its contour has a generally rectangular shape and is straight on all of the four sides.

Each of the solid electrolyte bodies 136 shown in FIGS. 4(A) through 4(D) is preferred, from the viewpoint that the entire contour of the solid electrolyte body 136 forms a circular shape, or a portion of the counter corresponding to at least one side of the solid electrolyte body 136 (when it has one side or a plurality of sides) forms an arcuate shape. In other words, each of the solid electrolyte bodies 136 shown in FIGS. 4(A) through 4(D) is preferred, from the viewpoint that, as viewed on a plane orthogonal to the thickness direction of the insulating member 139 including the solid electrolyte body 136, a portion of the contour of the solid electrolyte body 136, which portion faces at least one side of the four sides of the insulating member 139, has an arcuate shape projecting toward that one side. Namely, since each of the solid electrolyte bodies 136 shown in FIGS. 4(A) through 4(D) is formed such that a portion of the contour of the solid electrolyte body 136, which portion faces at least one side of the four sides of the insulating member 139, has an arcuate shape projecting toward that one side, each of the solid electrolyte bodies 136 shown in FIGS. 4(A) through 4(D) has an advantage that, when an external force or a stress such as thermal stress acts on the solid electrolyte body 136, excessive stress concentration is less likely to occur, and the possibility of breakage due to stress concentration is low, as compared with the comparative example shown in FIG. 4(E). Also, from the viewpoint of mitigating stress concentration, it is preferred that the solid electrolyte body 136 be formed such that the contour of the solid electrolyte body 136 does not have any point of intersection between two sides (for example, a point corresponding to an apex of a polygon) the interior angle between which is 90 degrees or less. In particular, the flat oval shape, the circular shape, and the elliptical shape described with reference to FIGS. 4(A) and 4(B) do not have, over the entire contour, such a point of intersection between two sides, the interior angle between which is 90 degrees or less, and are smooth in change. Therefore, their stress concentration mitigating effect is remarkable. Also, from the viewpoint of reducing the size of the gas sensor 100, it is preferred that portions of the contour of the solid electrolyte body 136 which face longitudinally extending sides among the four sides of the insulating member extend straight in the longitudinal direction; i.e., each form the shape of a longitudinally extending straight line. More specifically, miniaturization of the gas sensor 100 requires miniaturization of the solid electrolyte body 136. However, the solid electrolyte body 136 must have a predetermined area, because electrodes are disposed thereon. For example, the circular shape shown in FIG. 4(B) is disadvantageous from the viewpoint of sufficiently increasing the area of the solid electrolyte body 136. In contrast, the flat oval shape and the wedge-like shape shown in FIGS. 4(A), 4(C), and 4(D) are advantageous from that viewpoint and are therefore preferred.

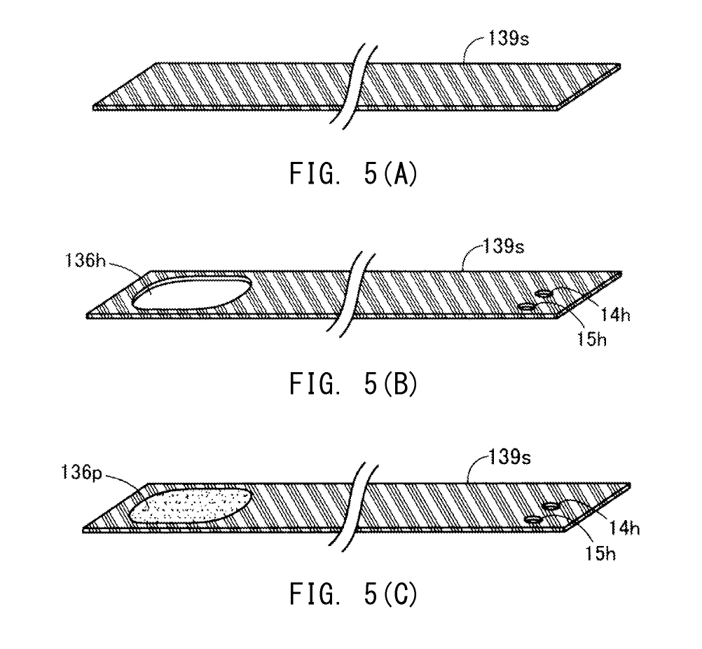

FIGS. 5(A) through 5(C) are explanatory views showing a first method of manufacturing a plate-shaped member including a solid electrolyte body and an insulating member. In the following description of the manufacturing method as well, the oxygen pump cell 135 is chosen as a representative, like the description given with reference to FIGS. 4(A) through 4(E).

In a step shown in FIG. 5(A), a green insulating member sheet 139s having neither a hole nor a through-hole is prepared. In a step shown in FIG. 5(B), portions of the green insulating member sheet 139s are removed through punching so as to form a through-hole 136h for the solid electrolyte body 136 and through-holes 14h and 15h for the through-hole conductors 14 and 15. In a step shown in FIG. 5(C), a green solid electrolyte body 136p is embedded in the through-hole 136h, whereby a green insulating member sheet 139s having the green solid electrolyte body 136p embedded therein is formed. Notably, this embedding step can be performed by placing a green solid electrolyte sheet on the green insulating member sheet 139s having the through-hole 136h (FIG. 5(B)), and punching the green solid electrolyte sheet from the upper side thereof such that a portion of the green solid electrolyte sheet having a shape corresponding to the shape of the through-hole 136h is removed from the green solid electrolyte sheet and is placed in the through-hole 136h. Notably, after the steps shown in FIGS. 5(A) through 5(C), the gas sensor element 120 is completed through a plurality of steps including a step of applying green electrode patterns, a step of forming a green laminate by laminating other green plate-shaped members on the green insulating member sheet 139s, and a step of firing the laminate. Notably, a manufacturing method described in FIGS. 3 to 9 of the above-described Patent Document 2 (Japanese Patent No. 4669429) can be employed so as to manufacture the gas sensor element 120.

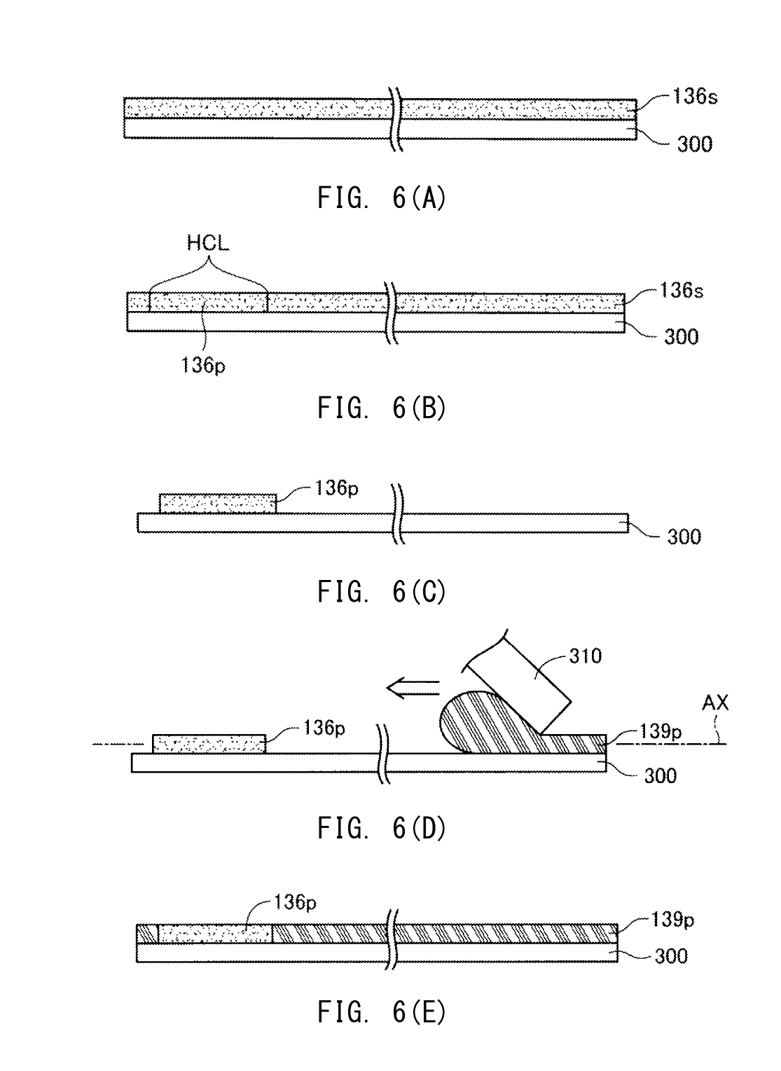

FIGS. 6(A) through 6(E) are explanatory views showing a second method of manufacturing a plate-shaped member including a solid electrolyte body and an insulating member. In a step shown in FIG. 6(A), a green solid electrolyte layer 136s formed of a green solid electrolyte material is formed on a support sheet 300. The green solid electrolyte layer 136s can be formed by an arbitrary method such as screen printing. In a step shown in FIG. 6(B), a slit or cut line HCL (half cut line) is formed in the green solid electrolyte layer 136s along a green solid electrolyte body 136p which is a portion of the green solid electrolyte layer 136s and which is to become the solid electrolyte body 136 after firing. The half cut line HCL is a cut line or slit which penetrates through the green solid electrolyte layer 136s but does not penetrate through the support sheet 300. In a step shown in FIG. 6(C), the green solid electrolyte material, excluding the green solid electrolyte body 136p, is removed from the green solid electrolyte layer 136s. In a step shown in FIG. 6(D), a green insulating material is applied, by means of printing (for example, screen printing), onto the support sheet 300 having the green solid electrolyte body 136p disposed thereon, to thereby form a green insulating layer 139p. When screen printing is performed, a squeegee 310 for screen printing proceeds on the support sheet 300 in a direction (direction from the right toward the left in the drawing) corresponding to the direction of the axial line AX of the gas sensor 100. In the case where a solid electrolyte body 136 having any one of the contour shapes shown in FIGS. 4(A) through 4(D) is employed, in the step of FIG. 6(D), the squeegee 310 first reaches the rear end (the right-hand end in the drawing) of the green solid electrolyte body 136p where the contour thereof has an arcuate shape. Accordingly, at the time of screen printing, air is less likely to remain between the green solid electrolyte body 136p and the green insulating layer 139p, and a useless gap is less likely to be formed therebetween. From the viewpoint of preventing air from remaining between the green solid electrolyte body 136p and the green insulating layer 139p, it is preferred that the contour of the green solid electrolyte body 136p have an arcuate shape at the left end (the left-hand end in the drawing) of the green solid electrolyte body 136p as well; i.e., it is preferred to employ a solid electrolyte body 136 having any one of the contour shapes shown in FIGS. 4(A) through 4(C). Also, from the viewpoint of easiness of manufacture, it is more preferred that the shape of the solid electrolyte body 136 be a circle, a flat oval, or an ellipse.

FIG. 6(E) shows a state in which a green plate-shaped member composed of the green solid electrolyte body 136p and the green insulating layer 139p is formed on the support sheet 300. After that, the gas sensor element 120 is completed through a plurality of steps including a step of applying green electrode patterns, a step of forming a green laminate by laminating other green plate-shaped members on the green plate-shaped member, and a step of firing the laminate.

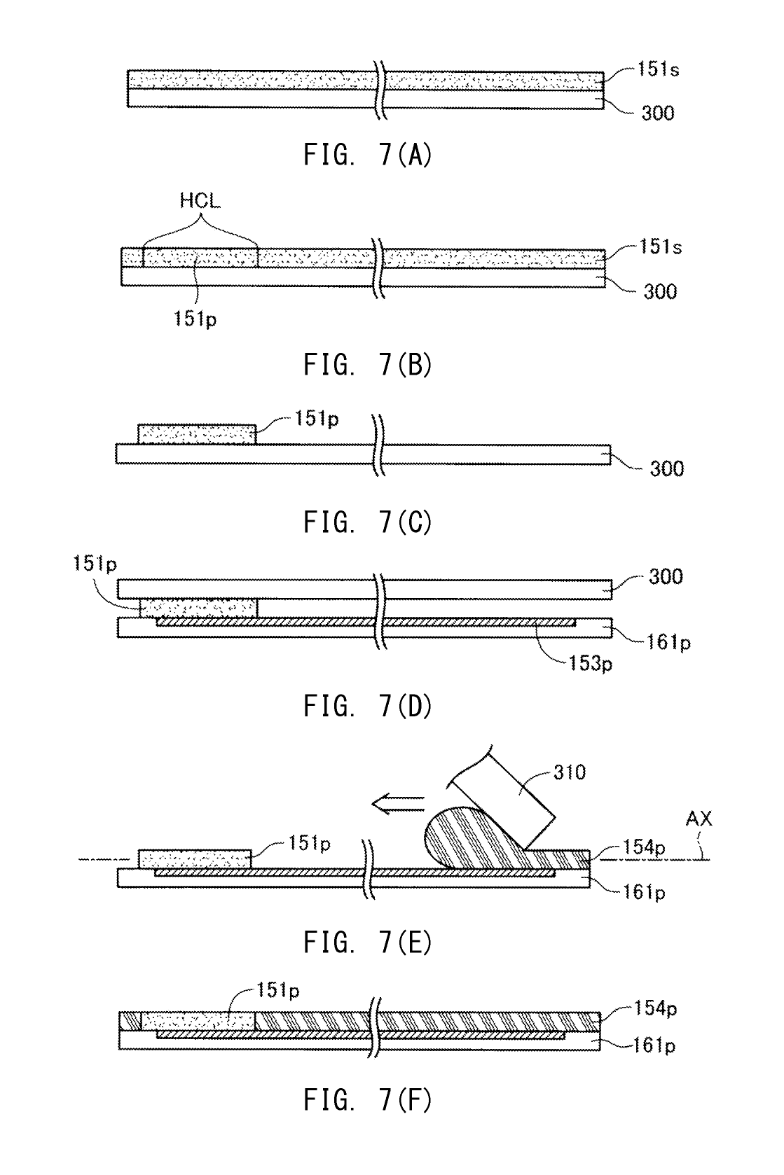

FIGS. 7(A) through 7(F) are explanatory views showing a third method of manufacturing a plate-shaped member including a solid electrolyte body and an insulating member. This third manufacturing method can be utilized as a method of manufacturing the plate-shaped member including the solid electrolyte body 151 of the oxygen concentration detection cell 150 (FIG. 3). Steps of FIGS. 7(A) through 7(C) are the same as the steps of FIGS. 6(A) through 6(C). In these steps, a green solid electrolyte layer 151s is formed on a support sheet 300, a half cut line HCL is formed around a green solid electrolyte body 151p, and the green solid electrolyte material, excluding the green solid electrolyte body 151p, is removed. In a transfer step of FIG. 7(D), the green solid electrolyte body 151p is transferred onto a green insulating layer 161p which is prepared separately and is formed of a green insulating material, and the support sheet 300 is peeled off. Notably, it is preferred that a green electrode pattern 153p which is to become the electrode 153 (FIG. 3) after firing be formed on the surface of the green insulating layer 161p. Steps of FIGS. 7(E) and 7(F) are the same as the steps of FIGS. 6(D) and 6(E). In these steps, a green insulating layer 154p is formed by applying a green insulating material, by means of printing (for example, screen printing), on the green insulating layer 161p. After that, the gas sensor element 120 is completed through a plurality of steps including a step of applying green electrode patterns, a step of forming a green laminate by laminating other green plate-shaped members on the green plate-shaped member, and a step of firing the laminate.

As described above, in the present embodiment, the solid electrolyte body 136 embedded in the through-hole of the insulating member 139 does not have a rectangular contour but has a contour which forms an arcuate shape projecting toward at least one side of the four sides of the insulating member 139. Therefore, the solid electrolyte body 136 having such a contour has an advantage that, even when an external force or a stress such as thermal stress acts on the solid electrolyte body 136, stress concentration is less likely to occur. Also, when the green insulating layer 139p is formed around the green solid electrolyte body 136p by means of printing, air is less likely to remain between the green solid electrolyte body 136p and the green insulating layer 139p. Therefore, the possibility of formation of a useless gap between the green solid electrolyte body 136p and the green insulating layer 139p can be decreased.

C. Modifications:

The present invention is not limited to the above-described embodiment, but may be embodied in various other forms without departing from the gist of the invention.

### Modified Embodiment 1

The overall structure of the above-described gas sensor 100 is a mere example, and various other structures may be employed. Also, in the above-described embodiments, the gas sensor 100 detects the concentration of oxygen gas contained in gas to be measured, by using the oxygen-ion conductive solid electrolyte bodies 136 and 151. However, the present invention can be applied to a gas sensor which detects the concentration of a gas other than oxygen.

### DESCRIPTION OF REFERENCE NUMERALS

11-18, 21: through-hole conductor
100: gas sensor
101: protector
101c: introduction hole
103: outer tube
110: metallic shell
110a: threaded portion
110b: tool engagement portion
110c: through-hole
110k: end portion
111: stepped portion
113: ceramic holder
113c: through-hole
114: first powder filler layer
115: second powder filler layer
116: metal cup
116c: through-hole
117: crimp ring
120: gas sensor element
121: gas detecting section
125-128: electrode pad
130: detection element
131: protection layer
132: porous section
135: oxygen pump cell
136: solid electrolyte body
136h: through-hole
136p: green solid electrolyte body
136s: green solid electrolyte layer
137: electrode
137L: lead portion
137M: electrode portion
138: electrode
138L: lead portion
138M: electrode portion
139: insulating member
139p: green insulating layer
139s: insulating member sheet
145: spacer
145c: gas detecting chamber
146: diffusion controlling portion
150: oxygen concentration detection cell
151: solid electrolyte body
151p: green solid electrolyte body
151s: green solid electrolyte layer
152: electrode
152L: lead portion
152M: electrode portion
153: electrode
153p: green electrode pattern
153L: lead portion
154: insulating member
160: heater element
161, 162: second insulator
161p: green insulating layer
163: heat-generating resistor
164: heater lead portion
170: ceramic sleeve
170c: axial hole
181: separator
181c: through-hole
182: connection terminal
185: connection terminal
190: urging metal member
191: grommet
193: lead wire for sensor
196: lead wire for heater
300: support sheet
310: squeegee

What is claimed is:

1. A gas sensor element comprising a plurality of laminated plate-shaped members, including a plate-shaped insulating member in which a solid electrolyte body is embedded and which has four sides, wherein
as viewed in a plane orthogonal to a thickness direction of the insulating member including the solid electrolyte body, a portion of a contour of the solid electrolyte body has an arcuate shape projecting toward at least one side of the four sides.

2. The gas sensor element of claim 1, wherein a shape of the solid electrolyte body is a circle, an ellipse, or a rectangle with rounded short sides.

3. The gas sensor element of claim 1, wherein another portion of the contour of the solid electrolyte body has a shape of a longitudinally extending straight line facing a longitudinally extending side of the four sides.

4. A method of manufacturing the gas sensor element of claim 1, the method comprising:
(a) a step of forming a green solid electrolyte layer formed of a green solid electrolyte material on a support sheet;
(b) a step of removing, from the green solid electrolyte layer on the support sheet, a portion of the green solid electrolyte material excluding a green solid electrolyte body which is to become the solid electrolyte body of the gas sensor element;
(c) a step of transferring the green solid electrolyte body onto a green insulating layer formed of a green insulating material; and
(d) a step of forming a green plate-shaped member in which the green solid electrolyte body is surrounded by the green insulating material by applying the green insulating material by means of printing on the green insulating layer in a region around the transferred green solid electrolyte body.

5. A gas sensor including the gas sensor element of claim 1, the gas sensor for detecting a particular gas contained in gas to be measured.
